(19) United States
(12) Patent Application Publication
(10) Pub. No.: US 2025/0199837 A1
(43) Pub. Date: Jun. 19, 2025

(54) VIRTUAL MACHINE MIGRATION WITH VIRTUAL CPU DESCRIPTORS

(71) Applicant: Red Hat, Inc., Raleigh, NC (US)

(72) Inventors: Leigh Griffin, Waterford (IE); Anthony Francis Carroll, Waterford (IE); Ellen O'Carroll, Waterford (IE)

(21) Appl. No.: 18/541,760

(22) Filed: Dec. 15, 2023

(51) Int. Cl. G06F 9/455

(52) U.S. Cl. CPC G06F 9/45558; G06F 2009/45562; G06F 2009/4557

(57) ABSTRACT

A computing device determines that a workload of a first virtual machine is to be transferred to a second virtual machine. The computing device generates a file comprising virtual CPU (vCPU) data that describes current conditions of the first virtual machine. The computing device transmits the file from the first virtual machine to the second virtual machine. The computing device restores the current conditions of the first virtual machine on the second virtual machine based on the file. The computing device sends a signal to the first virtual machine indicating that the current conditions of the first virtual machine are restored on the second virtual machine.

### BACKGROUND

Virtual machines are virtual environments that function as virtual computer systems created on physical hardware systems or hosts. A virtual machine can be migrated from one host to another host.

### SUMMARY

The examples disclosed herein implement a hypervisor that performs virtual machine migration with virtual CPU descriptors. In particular, the hypervisor can determine that a workload executing on a virtual machine is to be migrated to another virtual machine. A file with data that describes a virtual CPU (vCPU) of the virtual machine that is to be migrated can be passed to the new virtual machine, allowing for a transfer of control at the vCPU level. As a result, the conditions of the virtual machine that is being migrated, such as the state and execution points in programs running on the virtual machine, can be restored in the same state and at the same execution points on the new virtual machine with minimal latency.

In one example, a method for virtual machine migration with virtual CPU descriptors is provided. The method includes determining, by a hypervisor executing on a computing device, that a workload of a first virtual machine is to be transferred to a second virtual machine. The method further includes generating, by the hypervisor, a file comprising virtual CPU (vCPU) data that describes current conditions of the first virtual machine. The method further includes transmitting, by the hypervisor, the file from the first virtual machine to the second virtual machine. The method further includes restoring, by the hypervisor, the current conditions of the first virtual machine on the second virtual machine based on the file. The method further includes sending, by the hypervisor, a signal to the first virtual machine indicating that the current conditions of the first virtual machine are restored on the second virtual machine.

In another example, a computing device for virtual machine migration with virtual CPU descriptors is provided. The computing device includes a memory and a processor device coupled to the memory. The processor device is to determine that a workload of a first virtual machine is to be transferred to a second virtual machine. The processor device is further to generate a file comprising virtual CPU (vCPU) data that describes current conditions of the first virtual machine. The processor device is further to transmit the file from the first virtual machine to the second virtual machine. The processor device is further to restore the current conditions of the first virtual machine on the second virtual machine based on the file. The processor device is further to send a signal to the first virtual machine indicating that the current conditions of the first virtual machine are restored on the second virtual machine.

In another example, a non-transitory computer-readable storage medium for virtual machine migration with virtual CPU descriptors is provided. The non-transitory computer-readable storage medium includes computer-executable instructions to cause a processor device to determine that a workload of a first virtual machine is to be transferred to a second virtual machine. The instructions further cause the processor device to generate a file comprising virtual CPU (vCPU) data that describes current conditions of the first virtual machine. The instructions further cause the processor device to transmit the file from the first virtual machine to the second virtual machine. The instructions further cause the processor device to restore the current conditions of the first virtual machine on the second virtual machine based on the file. The instructions further cause the processor device to send a signal to the first virtual machine indicating that the current conditions of the first virtual machine are restored on the second virtual machine.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a computing device in which examples of virtual machine migration with virtual CPU descriptors may be practiced;

FIG. 1B is a block diagram of a computing device in which examples of virtual machine migration with virtual CPU descriptors may be practiced;

FIG. 2 is a flowchart illustrating operations performed by the

computing device of FIG. 1A for virtual machine migration with virtual CPU descriptors, according to one example;

FIG. 3 is a block diagram of the computing device of FIG. 1A for virtual machine migration with virtual CPU descriptors, according to one example;

FIG. 4 is a block diagram of the computing device of FIG. 1A for virtual machine migration with virtual CPU descriptors, according to one example;

FIG. 5 is a block diagram of the computing device of FIG. 1A for virtual machine migration with virtual CPU descriptors, according to one example; and

FIG. 6 is a block diagram of a computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Virtual machines are virtual environments that function as virtual computer systems created on physical hardware systems or hosts. A virtual machine (VM) typically runs a guest operating system in conjunction with a virtual machine monitor (VMM), such as a hypervisor, that is configured to coordinate access to physical resources of a physical machine, such as a memory and a processor device, by the virtual machine running on the physical machine. A VM can be migrated from one host to another host or from one cluster to another cluster to change one or more computing resources that the VM runs on. However, the migration of virtual machines can result in unpredictable latencies and downtime, which can impact the performance of applications running on the virtual machines.

The examples disclosed herein implement a hypervisor that performs virtual machine migration with virtual CPU (virtual central processing unit) descriptors without affecting latency or downtime when migrating virtual machines. In particular, the hypervisor can determine that a workload executing on a VM is to be migrated to another VM. A file with data that describes a virtual CPU (vCPU) of the VM that is to be migrated can be passed to the new VM, allowing for a transfer of control at the vCPU level without awareness at the client or user level. As a result, the conditions of the VM that is being migrated, such as the state and execution points in programs running on the VM, can be restored in the same state and at the same execution points on the new VM with minimal latency and impact on performance since the VM does not need to be paused to capture the state of the VM before instantiating the state in the new VM. In some implementations, the VM that is being migrated may use the same computing resources on a computing device and the same hypervisor as the new VM, and in other implementations, the virtual machines may be implemented with different hypervisors executing on different computing devices.

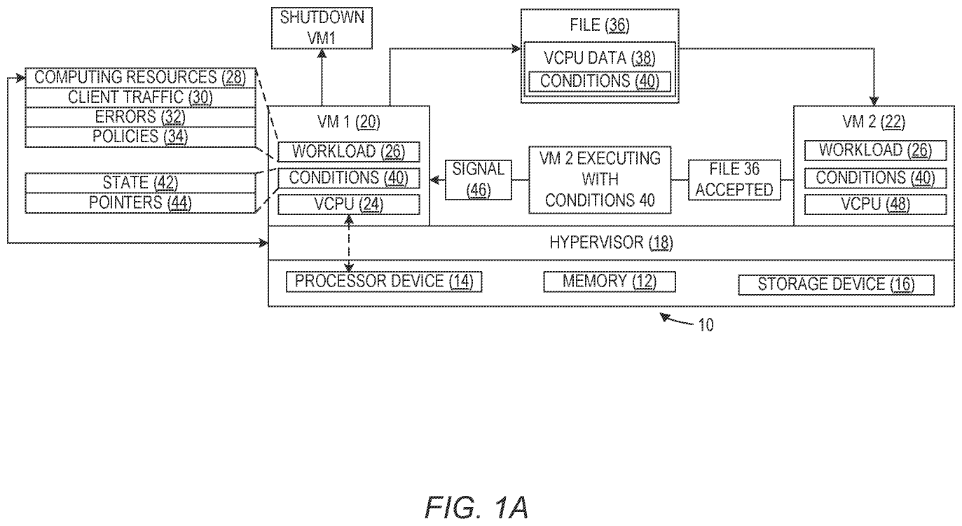

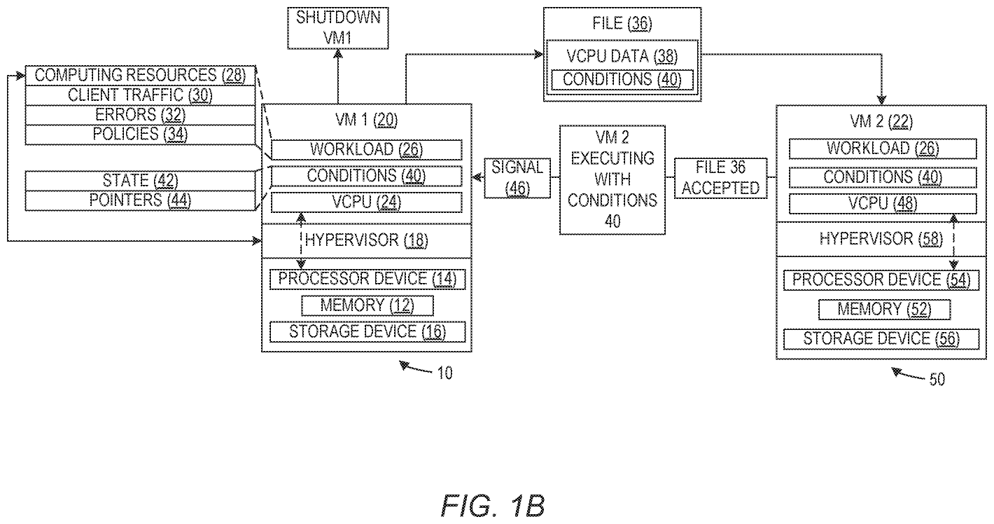

FIG. 1A is a block diagram of a computing device 10 that comprises a system memory 12, a processor device 14, and a storage device 16 in which examples of virtual machine migration with virtual CPU descriptors may be practiced. It is to be understood that the computing device 10 in some examples may include constituent elements in addition to those illustrated in FIG. 1A. In the example of FIG. 1A, the computing device 10 implements a hypervisor 18 that performs virtual machine migration with virtual CPU descriptors.

A virtual machine monitor (VMM), referred to herein as the hypervisor 18, implements a virtualized environment via VM virtualization technology on the computing device 10. The VM virtualization technology may comprise, by way of non-limiting example, Red Hat Enterprise Linux virtualization technology, VMware® virtualization technology, Microsoft® Hyper-V virtualization technology, Oracle VM Server for SPARC virtualization technology, or the like. The hypervisor 18 may be implemented as software that creates and executes one or more virtual machines on a physical machine (e.g., the computing device 10), isolates the guest operating systems of the virtual machines from the hardware of the physical machine, and allocates the computing resources of the physical machine, such as CPU, memory, and storage, to the virtual machines. In the example of FIG. 1A, the hypervisor 18 can execute on the computing device 10 and can allocate the computing resources of the computing device 10, such as the system memory 12, the processor device 14, and the storage device 16, to a first virtual machine (VM) 20. The hypervisor 18 can also allocate the computing resources of the computing device 10 to a second virtual machine (VM) 22.

A vCPU is an abstraction of a physical CPU that represents at least a portion of the physical CPU that is assigned to a VM, and there may be multiple vCPUs per virtual machine. The hypervisor 18 can provide the first VM 20 with a virtual CPU (vCPU) 24 from among a plurality of vCPUs. For instance, the vCPU 24 is a construct used by the hypervisor 18 to allocate processing time to the first VM 20 on the processor device 14 of the computing device 10. The hypervisor 18 can take at least a portion of the processor device 14 and allocate it to the vCPU 24 that is assigned to the first VM 20. The second VM 22 can also be provided a vCPU 48 from among the plurality of vCPUs and the hypervisor 18 can allocate at least a portion of the processor device 14 or another processor device of the computing device 10 to the vCPU 48 that is assigned to the second VM 22.

The hypervisor 18 may determine that a workload 26 of the first VM 20 is to be transferred or migrated to the second VM 22. The second VM 22 may already be executing when the hypervisor 18 makes the determination to migrate the workload 26 from the first VM 20 to the second VM 22. The hypervisor 18 may determine that the workload 26 of the first VM 20 should be migrated by determining that one or more parameters of the first VM 20, such as the computing resources 28, client computing device traffic 30, errors 32 occurring, or policies 34, as non-limiting examples, of the first VM 20 are insufficient for the workload 26 of the first VM 20 to continue executing. The hypervisor 18 may determine that the workload 26 of the first VM 20 should be migrated by also determining that one or more corresponding parameters of the second VM 22 are sufficient for the workload 26 to execute. In some examples, the first VM 20 may be associated with a ruleset that defines current parameters of the first VM 20 and thresholds where the parameters are invalidated, such as a threshold amount of memory, errors, or client connections, as non-limiting examples. The workload 26 may be a current workload of the first VM 20 or a future workload of the first VM 20, such as an expected increase in the use of computing resources by the first VM 20 at a future time. For instance, based on the ruleset, the hypervisor 18 can determine that a process that is scheduled to execute will increase the amount of memory consumed by the first VM 20 to a level above a threshold limit of memory that is allocated to the first VM 20, and the hypervisor 18 can determine to transfer the workload 26 to the second VM 22 that has more memory available as preemptive maintenance.

For example, the workload 26 may be an application that is executing on the first VM 20 and the hypervisor 18 may determine that the application cannot continue executing on the first VM 20 with the computing resources 28 that are currently allocated to the first VM 20. In some implementations, the hypervisor 18 may determine that one or more parameters of the first VM 20 are insufficient for the workload 26 of the first VM 20 by obtaining data that describes the computing resources 28 of the first VM 20 and determining, based on the data, that additional computing resources, such as more memory, are needed for the first VM 20. For instance, the hypervisor 18 may obtain data such as a threshold amount of a computing resource and a current usage of the computing resource by the first VM 20 and determine that an additional amount of the computing resource is needed for the first VM 20 to continue executing without exceeding the threshold. The hypervisor 18 may then obtain data such as a threshold amount of the same computing resource and the current usage of the computing resource by the second VM 22 and determine that the second VM 22 has the additional amount of the computing resource is needed for the first VM 20 to continue executing.

In another example, the workload 26 may be a process that is executing on the first VM 20 and the hypervisor 18 may determine that the process cannot continue executing on the first VM 20 because there is a high amount of client computing device traffic 30 or errors 32 that are impacting the ability for the process to execute on the first VM 20. The policies 34 can include policies of the computing system for protection, such as service level agreements SLAs) or authorization policies, as non-limiting examples, that should not be violated, so the hypervisor 18 can determine that the workload 26 should be migrated because one or more of the policies 34 would be violated if the workload 26 continued operating on the first VM 20.

The hypervisor 18 may generate a file 36 that includes vCPU data 38 that describes current conditions 40 of the first VM 20. Instead of causing the vCPU 24 to exit and saving the state of the vCPU 24 or the first VM 20, the vCPU data 38 in the file 36 is passed to the second VM 22 to transition the first VM 20 to the second VM 22 without shutting down the first VM 20. The vCPU data 38 can include a current state 42 of the first VM 20, as well as other data and information needed to transfer the workload 26 from the first VM 20 to the second VM 22, such as connections between client computing devices that are accessing the first VM 20, pointers to other vCPUs and physical components of the computing device 10, pointers to execution points in processes and applications executing on the first VM 20, process ids (PIDs) of processes executing on the first VM 20, or clock speed, processing units, and other information about the vCPU 24, as non-limiting examples. The hypervisor 18 can transmit the file 36 with the vCPU data 38 from the first VM 20 to the second VM 22. In some implementations, a group that includes one or more vCPUs of the first VM 20 (e.g., the vCPU 24) and one or more vCPUs of the second VM 22 (e.g., the vCPU 48) can be created as a shared group with shared visibility of all the vCPUs in the group, and the file 36 can be passed from the first VM 20 to the one or more of the vCPUs of the second VM 22 (e.g., the vCPU 48).

The hypervisor 18 can restore the current conditions 40 of the first VM 20 on the second VM 22 based on the file 36 with the vCPU data 38 that was transmitted from the first VM 20 to the second VM 22. As a result, the second VM 22 can resume the workload 26 at the same execution points as when the workload 26 was executing on the first VM 20 with minimal latency and impact on performance since the vCPU data 38 contains the information about the vCPU 24 that is needed to resume execution of the workload 26 on the second VM 22 without exiting, saving the state of the first VM 20, and transferring the state to the second VM 22. For example, the state 42 of the first VM 20 can be included in the vCPU data 38 in the file 36 and the hypervisor 18 can restore the current conditions 40 of the first VM 20 on the second VM 22 by instantiating the second VM 22 with the state 42 of the first VM 20, and the vCPU data 38 can also include a plurality of pointers 44 that identify the execution points of the processes and applications that were executing on the first VM 20 so that the hypervisor 18 can initiate the second VM 22 at the same execution points.

The hypervisor 18 may send a signal 46 to the first VM 20 to indicate that the current conditions 40 and the workload 26 of the first VM 20 are restored on the second VM 22. The signal 46 may include a message or a notification, as non-limiting examples. The signal 46 can also include information indicating that the second VM 22 is on the same processor clock, operand execution, and client connections, as non-limiting examples, as that the first VM 20 was prior to migration. In some implementations, the hypervisor 18 may perform a validation check where, prior to sending the signal 46, the hypervisor 18 may determine that the file 36 was accepted by the second VM 22 and that the second VM 22 is successfully executing the workload 26 with the current conditions 40 of the first VM 20. The hypervisor 18 can then send the signal 46 to the first VM 20 in response to determining that the file 36 was accepted by the second VM 22 and that the second VM 22 is executing the workload 26 with the current conditions 40 of the first VM 20. After sending the signal 46 to the first VM 20 to indicate that the current conditions 40 and the workload 26 of the first VM 20 are restored on the second VM 22, the hypervisor 18 may shut down and terminate the first VM 20. Prior to shutting down the first VM 20, the hypervisor 18 can reroute client requests that were associated with the first VM 20 to the second VM 22, such as in response to sending the signal 46 or after sending the signal 46. In some examples, the hypervisor 18 may pause the first VM 20 or reallocate the computing resources of the first VM 20 after sending the signal 46 to the first VM 20.

It is to be understood that, because the hypervisor 18 is a component of the computing device 10, functionality implemented by the hypervisor 18 may be attributed to the computing device 10 generally. Moreover, in examples where the hypervisor 18 comprises software instructions that program the processor device 14 to carry out functionality discussed herein, functionality implemented by the hypervisor 18 may be attributed herein to the processor device 14. It is to be further understood that while, for purposes of illustration only, the hypervisor 18 is depicted as a single component, the functionality implemented by the hypervisor 18 may be implemented in any number of components, and the examples discussed herein are not limited to any particular number of components.

FIG. 1B is a block diagram of the computing device 10 and a computing device 50 that comprises a system memory 52, a processor device 54, and a storage device 56 in which examples of virtual machine migration with virtual CPU descriptors may be practiced. It is to be understood that the computing device 50 in some examples may include constituent elements in addition to those illustrated in FIG. 1B. In the example of FIG. 1B, the computing device 50 implements a hypervisor 58 that performs virtual machine migration with virtual CPU descriptors. The hypervisor 58 can execute on the computing device 50 and can allocate the computing resources of the computing device 50, such as the system memory 52, the processor device 54, and the storage device 56, to the second VM 22. The hypervisor 58 can provide the second VM 22 with a vCPU 48 from among a plurality of vCPUs and allocate at least a portion of the processor device 54 or another processor device of the computing device 50 to the vCPU 48. In the example of FIG. 1B, functionality implemented by the hypervisor 18 may be attributed to the hypervisor 58.

In the example of FIG. 1B, the workload 26 may be transferred from the first VM 20 to the second VM 22 where the first VM 20 and the second VM 22 operate on different physical machines or hosts, the computing device 10 and the computing device 50 respectively. The hypervisor 18 may determine that the workload 26 of the first VM 20 is to be transferred or migrated to the second VM 22. The second VM 22 may already be executing when the hypervisor 18 makes the determination to migrate the workload 26 from the first VM 20 to the second

VM 22. The hypervisor 18 may determine that the workload 26 of the first VM 20 should be migrated by determining that one or more parameters of the first VM 20, such as the computing resources 28, the client computing device traffic 30, the errors 32 occurring, or the policies 34, as non-limiting examples, of the first VM 20 are insufficient for the workload 26 of the first VM 20 to continue executing. The hypervisor 18 may determine that the workload 26 of the first VM 20 should be migrated by also determining that one or more corresponding parameters of the second VM 22 are sufficient for the workload 26 to execute.

The hypervisor 18 may generate the file 36 that includes the vCPU data 38 that describes the current conditions 40 of the first VM 20, such as the current state 42 of the first VM 20, as well as other data and information needed to transfer the workload 26 from the first VM 20 to the second VM 22, such as connections between client computing devices that are accessing the first VM 20, pointers to other vCPUs and physical components of the computing device 10, pointers to execution points in processes and applications executing on the first VM 20, process ids (PIDs) of processes executing on the first VM 20, or clock speed, processing units, and other information about the vCPU 24, as non-limiting examples. Instead of causing the vCPU 24 to exit and saving the state of the vCPU 24 or the first VM 20, the vCPU data 38 in the file 36 is passed to the second VM 22 to transition the first VM 20 without shutting down the first VM 20. The hypervisor 18 can transmit the file 36 with the vCPU data 38 from the first VM 20 to the second VM 22. In some implementations, a group that includes the vCPU 24 and the vCPU 48 of the second VM 22 can be created as a shared group with shared visibility of all the vCPUs in the group, and the file 36 can be passed from the first VM 20 to the vCPU 48 of the second VM 22.

The hypervisor 18 can restore the current conditions 40 of the first VM 20 on the second VM 22 on the computing device 50 based on the file 36 with the vCPU data 38 that was transmitted from the first VM 20 to the second VM 22. As a result, the second VM 22 can resume the workload 26 on the second VM 22 on the computing device 50 at the same execution points as when the workload 26 was executing on the first VM 20 on the computing device 10 with minimal latency and impact on performance since the vCPU data 38 contains the information about the vCPU 24 that is needed to resume execution of the workload 26 on the second VM 22 without exiting, saving the state of the first VM 20, and transferring the state to the second VM 22.

The hypervisor 18 may send the signal 46 to the first VM 20 to indicate that the current conditions 40 and the workload 26 of the first VM 20 are restored on the second VM 22 on the computing device 50. In some implementations, the hypervisor 18 may perform a validation check where, prior to sending the signal 46, the hypervisor 18 may determine that the file 36 was accepted by the second VM 22 and that the second VM 22 is successfully executing the workload 26 with the current conditions 40 of the first VM 20. The hypervisor 18 can then send the signal 46 to the first VM 20 in response to determining that the file 36 was accepted by the second VM 22 and the second VM 22 is executing the workload 26 with the current conditions 40 of the first VM 20. After sending the signal 46 to the first VM 20 to indicate that the current conditions 40 and the workload 26 of the first VM 20 are restored on the second VM 22, the hypervisor 18 may pause or shut down and terminate the first VM 20.

It is to be understood that, because the hypervisor 58 is a component of the computing device 50, functionality implemented by the hypervisor 58 may be attributed to the computing device 50 generally. Moreover, in examples where the hypervisor 58 comprises software instructions that program the processor device 54 to carry out functionality discussed herein, functionality implemented by the hypervisor 58 may be attributed herein to the processor device 54. It is to be further understood that while, for purposes of illustration only, the hypervisor 58 is depicted as a single component, the functionality implemented by the hypervisor 58 may be implemented in any number of components, and the examples discussed herein are not limited to any particular number of components.

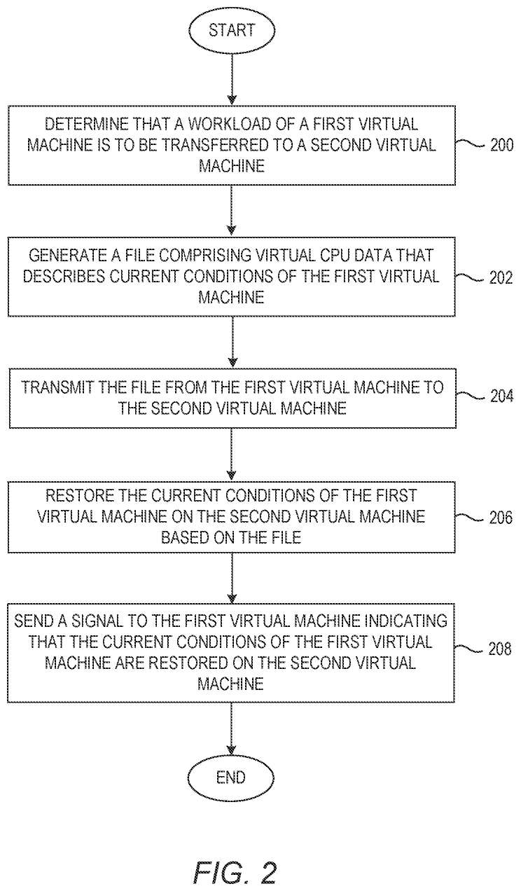

FIG. 2 is a flowchart illustrating operations performed by the computing device of FIG. 1A for virtual machine migration with virtual CPU descriptors, according to one example. Elements of FIG. 1A are referenced in describing FIG. 2 for the sake of clarity. In FIG. 2, operations begin with a processor device of a computing device, such as the processor device 14 of the computing device 10 of FIG. 1A, the processor device 14 to determine that a workload of a first virtual machine is to be transferred to a second virtual machine (block 200). The processor device 14 is further to generate a file comprising virtual CPU (vCPU) data that describes current conditions of the first virtual machine (block 202). The processor device 14 is further to transmit the file from the first virtual machine to the second virtual machine (block 204). The processor device 14 is further to restore the current conditions of the first virtual machine on the second virtual machine based on the file (block 206). The processor device 14 is further to send a signal to the first virtual machine indicating that the current conditions of the first virtual machine are restored on the second virtual machine (block 208).

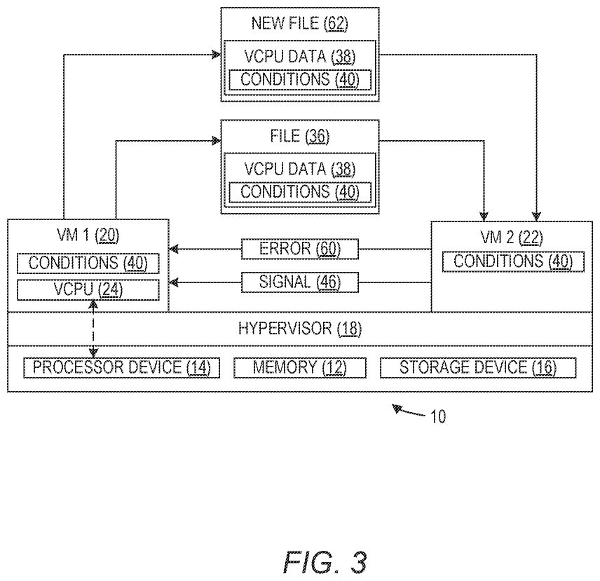

FIG. 3 is a block diagram of the computing device of FIG. 1A for virtual machine migration with virtual CPU descriptors, according to one example. Elements of FIG. 1A are referenced in describing FIG. 3 for the sake of clarity. In the example of FIG. 3, the hypervisor 18 may perform a validation check where, prior to sending the signal 46 to the first VM 20 to indicate that the current conditions 40 and the workload 26 of the first VM 20 are restored on the second VM 22, the hypervisor 18 receives an error 60, such as an error message or warning, that indicates that the error 60 occurred. For instance, the error 60 may occur during the transmission of the file 36 with the vCPU data 38 from the first VM 20 to the second VM 22, or when the current conditions 40 of the first VM 20 are being restored on the second VM 22, as non-limiting examples.

The hypervisor 18 can generate a new file 62 that includes the vCPU data 38 that describes the current conditions 40 of the first VM 20 and transmit the new file 62 from the first VM 20 to the second VM 22. The hypervisor 18 can then restore the current conditions 40 and the workload 26 of the first VM 20 on the second VM 22 based on the new file 62, such as by instantiating the second VM 22 with the state 42 of the first VM 20 and initiating the second VM 22 at the execution points of the first VM 20 based on the pointers 44 when the state 42 and the pointers 44 are included in the vCPU data 38. If another error occurs, the hypervisor 18 may try again to migrate the workload 26 from the first VM 20 to the second VM 22 by generating another new file with the vCPU data, transmitting the new file from the first VM 20 to the second VM 22, and restoring the current conditions 40 and the workload 26 of the first VM 20 on the second VM 22 based on the new file. Once the current conditions 40 and the workload 26 of the first VM 20 are restored on the second VM 22 and the second VM 22 is executing the workload 26 with the current conditions 40, the hypervisor 18 can send the signal 46 to the first VM 20 to indicate that the current conditions 40 and the workload 26 of the first VM 20 are restored on the second VM 22, and the hypervisor 18 may pause, shut down, or terminate the first VM 20.

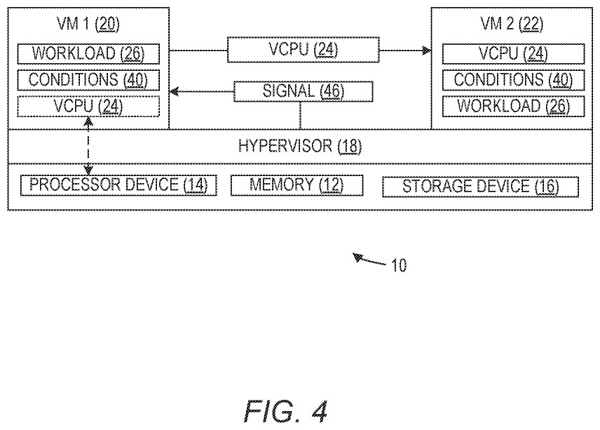

FIG. 4 is a block diagram of the computing device of FIG. 1A for virtual machine migration with virtual CPU descriptors, according to one example. Elements of FIG. 1A are referenced in describing FIG. 4 for the sake of clarity. In the example of FIG. 4, the hypervisor 18 may determine that the workload 26 of the first VM 20 is to be transferred or migrated to the second VM 22. The hypervisor 18 may determine that the workload 26 of the first VM 20 should be migrated by determining that one or more parameters of the first VM 20 (e.g., the computing resources 28, the client computing device traffic 30, the errors 32 occurring, or the policies 34, as non-limiting examples) are insufficient for the workload 26 to continue executing on the first VM 20, and that one or more corresponding parameters of the second VM 22 are sufficient for the workload 26 to execute.

Instead of causing the vCPU 24 to exit and saving the state of the vCPU 24 or the first VM 20, the vCPU 24 is passed to the second VM 22 in a running state to transition the first VM 20 to the second VM 22 without shutting down the first VM 20. The hypervisor 18 can transmit the vCPU 24 from the first VM 20 to the second VM 22, point the second VM 22 to the vCPU 24 that has been passed to the second VM 22, attach the hypervisor 18 to the already running vCPU 24, and disconnect the vCPU 24 from the first VM 20 to transfer control of the vCPU 24 from the first VM 20 to the second VM 22. In some implementations, the vCPU 24 can be attached to the file 36 and both the vCPU 24 and the file 36 can be transmitted from the first VM 20 to the second VM 22. The current conditions 40 of the first VM 20 can then be resumed on the second VM 22 with the workload 26 at the same execution points as the first VM 20 since the vCPU 24 has been reconnected to the second VM 22 along with the associations of the vCPU 24, resulting in minimal latency in the migration of the workload 26 from the first VM 20 to the second VM 22. The hypervisor 18 can send the signal 46 to the first VM 20 to indicate that the current conditions 40 and the workload 26 of the first VM 20 are restored on the second VM 22, and the first VM 20 may be paused, shut down, or terminated.

In some implementations, the second VM 22 may be managed by a separate hypervisor (e.g., the hypervisor 58) that allocates computing resources from another computing device (e.g., the computing device 50) to the second VM 22. The hypervisor 18 may determine that the workload 26 of the first VM 20 is to be transferred to the second VM 22 and transmit the vCPU 24 in a running state from the first VM 20 to the second VM 22 that is using the hypervisor 58. The hypervisor 18 can then point the second VM 22 to the vCPU 24 that has been passed to the second VM 22, attach the hypervisor 58 to the already running vCPU 24, and disconnect the vCPU 24 from the first VM 20 to transfer control of the vCPU 24 from the first VM 20 to the second VM 22. The current conditions 40 of the first VM 20 can then be resumed on the second VM 22 with the workload 26 at the same execution points as the first VM 20.

The hypervisor 18 or the hypervisor 58 can send the signal 46 to the first VM 20 to indicate that the current conditions 40 and the workload 26 of the first VM 20 are restored on the second VM 22, and the first VM 20 may be paused, shut down, or terminated. In some examples, the hypervisor 18 may perform a validation check where, prior to sending the signal 46 to the first VM 20 to indicate that the current conditions 40 and the workload 26 of the first VM 20 are restored on the second VM 22, the hypervisor 18 receives an error, such as an error message or warning, that indicates that the error occurred. For instance, the error may occur during the transmission of the vCPU 24 from the first VM 20 to the second VM 22, or when the current conditions 40 of the first VM 20 are being restored on the second VM 22, as non-limiting examples. The hypervisor 18 may attempt to send the vCPU 24 from the first VM 20 to the second VM 22 again until the signal 46 is sent to the first VM 20 indicating that the current conditions 40 and the workload 26 of the first VM 20 are restored on the second VM 22.

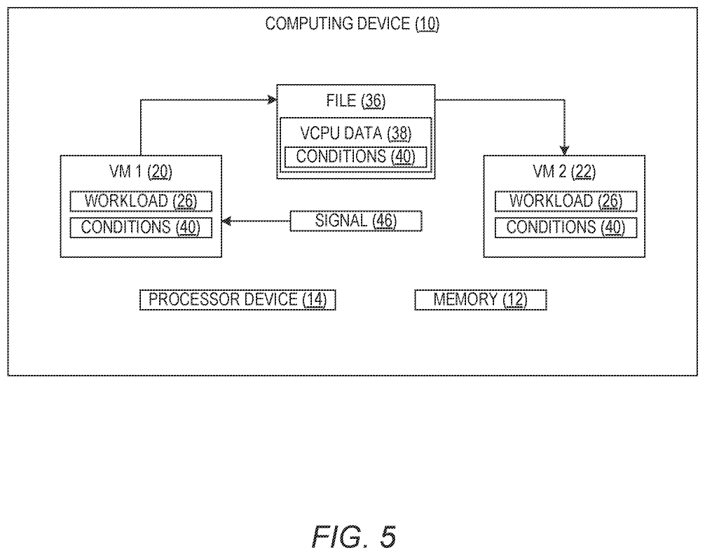

FIG. 5 is a block diagram of the computing device of FIG. 1A for virtual machine migration with virtual CPU descriptors, according to one example. Elements of FIG. 1A are referenced in describing FIG. 5 for the sake of clarity. In the example of FIG. 5, the computing device 10 includes a system memory 12 and a processor device 14 coupled to the system memory 12. The processor device 14 is to determine that a workload 26 of a first virtual machine 20 is to be transferred to a second virtual machine 22. The processor device 14 is further to generate a file 36 comprising virtual CPU (vCPU) data 38 that describes current conditions 40 of the first virtual machine 20. The processor device 14 is further to transmit the file 36 from the first virtual machine 20 to the second virtual machine 22. The processor device 14 is further to restore the current conditions 40 of the first virtual machine 20 on the second virtual machine 22 based on the file 36. The processor device 14 is further to send a signal 46 to the first virtual machine 20 indicating that the current conditions 40 of the first virtual machine 20 are restored on the second virtual machine 22.

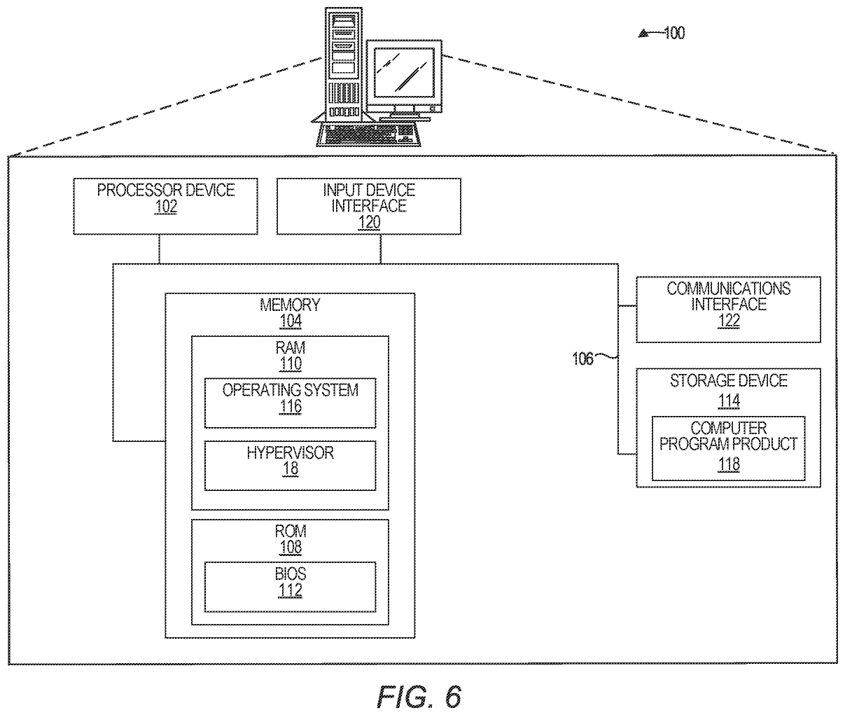

FIG. 6 is a block diagram of a computing device 100, such as the computing device 10 of FIG. 1A, suitable for implementing examples according to one example. The computing device 100 may comprise any computing or electronic device capable of including firmware, hardware, and/or executing software instructions to implement the functionality described herein. The computing device 100 includes a processor device 102, such as the processor device 14, a system memory 104, such as the system memory 12, and a system bus 106. The system bus 106 provides an interface for system components including, but not limited to, the system memory 104 and the processor device 102. The processor device 102 can be any commercially available or proprietary processor.

The system bus 106 may be any of several types of bus structures that may further interconnect to a memory bus (with or without a memory controller), a peripheral bus, and/or a local bus using any of a variety of commercially available bus architectures. The system memory 104 may include non-volatile memory 108 (e.g., read-only memory (ROM), erasable programmable read-only memory (EPROM), electrically erasable programmable read-only memory (EEPROM), etc.), and volatile memory 110 (e.g., random-access memory (RAM)). A basic input/output system (BIOS) 112 may be stored in the non-volatile memory 108 and can include the basic routines that help to transfer information between elements within the computing device 100. The volatile memory 110 may also include a high-speed RAM, such as static RAM, for caching data.

The computing device 100 may further include or be coupled to a non-transitory computer-readable storage medium such as a storage device 114, such as the storage device 16, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 114 and other drives associated with computer-readable media and computer-usable media may provide non-volatile storage of data, data structures, computer-executable instructions, and the like.

A number of modules can be stored in the storage device 114 and in the volatile memory 110, including an operating system 116 and one or more program modules, such as the hypervisor 18, which may implement the functionality described herein in whole or in part. All or a portion of the examples may be implemented as a computer program product 118 stored on a transitory or non-transitory computer-usable or computer-readable storage medium, such as the storage device 114, which includes complex programming instructions, such as complex computer-readable program code, to cause the processor device 102 to carry out the steps described herein. Thus, the computer-readable program code can comprise software instructions for implementing the functionality of the examples described herein when executed on the processor device 102. The processor device 102, in conjunction with the hypervisor 18 in the volatile memory 110, may serve as a controller, or control system, for the computing device 100 that is to implement the functionality described herein.

An operator, such as a user, may also be able to enter one or more configuration commands through a keyboard (not illustrated), a pointing device such as a mouse (not illustrated), or a touch-sensitive surface such as a display device (not illustrated). Such input devices may be connected to the processor device 102 through an input device interface 120 that is coupled to the system bus 106 but can be connected by other interfaces such as a parallel port, an Institute of Electrical and Electronic Engineers (IEEE) 1394 serial port, a Universal Serial Bus (USB) port, an IR interface, and the like. The computing device 100 may also include a communications interface 122 suitable for communicating with the network as appropriate or desired. The computing device 100 may also include a video port (not illustrated) configured to interface with the display device (not illustrated), to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
determining, by a hypervisor executing on a computing device, that a workload of a first virtual machine is to be transferred to a second virtual machine;
generating, by the hypervisor, a file comprising virtual CPU (vCPU) data that describes current conditions of the first virtual machine;
transmitting, by the hypervisor, the file from the first virtual machine to the second virtual machine;
restoring, by the hypervisor, the current conditions of the first virtual machine on the second virtual machine based on the file; and
sending, by the hypervisor, a signal to the first virtual machine indicating that the current conditions of the first virtual machine are restored on the second virtual machine.

2. The method of claim 1, wherein determining that the workload of the first virtual machine is to be transferred to the second virtual machine comprises determining that one or more parameters of the first virtual machine are insufficient for the workload of the first virtual machine.

3. The method of claim 2, wherein the one or more parameters of the first virtual machine comprise one or more of computing resources, client computing device traffic, errors, or policies.

4. The method of claim 2, wherein determining that one or more parameters of the first virtual machine are insufficient for the workload of the first virtual machine comprises:
obtaining data that describes computing resources of the first virtual machine; and
determining, based on the data, that additional computing resources are needed for the first virtual machine.

5. The method of claim 1, wherein restoring the current conditions of the first virtual machine on the second virtual machine based on the file comprises:
instantiating the second virtual machine with a state of the first virtual machine, wherein the state of the first virtual machine is included in the vCPU data; and
initiating the second virtual machine at an execution point of the first virtual machine based on a plurality of pointers in the vCPU data that identify the execution point of the first virtual machine.

6. The method of claim 1, further comprising:
prior to sending the signal to the first virtual machine indicating that the current conditions of the first virtual machine are restored on the second virtual machine, determining that the file was accepted by the second virtual machine; and
determining that the second virtual machine is executing the workload with the current conditions of the first virtual machine;
wherein sending the signal to the first virtual machine indicating that the current conditions of the first virtual machine are restored on the second virtual machine comprises sending the signal in response to determining that the file was accepted by the second virtual machine and the second virtual machine is executing the workload with the current conditions of the first virtual machine.

7. The method of claim 1, further comprising:
prior to sending the signal to the first virtual machine indicating that the current conditions of the first virtual machine are restored on the second virtual machine, receiving an error message indicating that an error occurred;
generating a new file comprising vCPU data that describes current conditions of the first virtual machine;
transmitting the new file from the first virtual machine to the second virtual machine; and
restoring the current conditions of the first virtual machine on the second virtual machine based on the new file.

8. The method of claim 1, further comprising:
subsequent to sending the signal to the first virtual machine indicating that the current conditions of the first virtual machine are restored on the second virtual machine, terminating the first virtual machine.

9. The method of claim 1, wherein the workload of the first virtual machine comprises a current workload of the first virtual machine or a future increase in workload of the first virtual machine.

10. The method of claim 1, wherein the vCPU data that describes the current conditions of the first virtual machine comprises one or more of a current state of the first virtual machine, connections between client computing devices and the first virtual machine, or pointers to a plurality of vCPUs.

11. The method of claim 1, further comprising:
creating a group comprising one or more vCPUs of the first virtual machine and one or more vCPUs of the second virtual machine, wherein transmitting the file from the first virtual machine to the second virtual machine comprises passing the file to one or more of the one or more vCPUs of the second virtual machine.

12. The method of claim 1, wherein the hypervisor is operable to allocate computing resources to the first virtual machine and the second virtual machine.

13. A computing device, comprising:
a memory; and
a processor device coupled to the memory, the processor device to:
determine that a workload of a first virtual machine is to be transferred to a second virtual machine;
generate a file comprising virtual CPU (vCPU) data that describes current conditions of the first virtual machine;
transmit the file from the first virtual machine to the second virtual machine;
restore the current conditions of the first virtual machine on the second virtual machine based on the file; and
send a signal to the first virtual machine indicating that the current conditions of the first virtual machine are restored on the second virtual machine.

14. The computing device of claim 13, wherein, to determine that the workload of the first virtual machine is to be transferred to the second virtual machine, the processor device is further to:
determine that one or more parameters of the first virtual machine are insufficient for the workload of the first virtual machine.

15. The computing device of claim 14, wherein, to determine that one or more parameters of the first virtual machine are insufficient for the workload of the first virtual machine, the processor device is further to:
obtain data that describes computing resources of the first virtual machine; and
determine, based on the data, that additional computing resources are needed for the first virtual machine.

16. The computing device of claim 13, wherein, to restore the current conditions of the first virtual machine on the second virtual machine based on the file, the processor device is further to:
instantiate the second virtual machine with a state of the first virtual machine, wherein the state of the first virtual machine is included in the vCPU data; and
initiate the second virtual machine at an execution point of the first virtual machine based on a plurality of pointers in the vCPU data that identify the execution point of the first virtual machine.

17. The computing device of claim 13, wherein the processor device is further to:
prior to sending the signal to the first virtual machine indicating that the current conditions of the first virtual machine are restored on the second virtual machine, determine that the file was accepted by the second virtual machine;
determine that the second virtual machine is executing the workload with the current conditions of the first virtual machine; and
wherein, to send the signal to the first virtual machine indicating that the current conditions of the first virtual machine are restored on the second virtual machine, the processor device is further to send the signal in response to determining that the file was accepted by the second virtual machine and the second virtual machine is executing the workload with the current conditions of the first virtual machine.

18. The computing device of claim 13, wherein the processor device is further to:
prior to sending the signal to the first virtual machine indicating that the current conditions of the first virtual machine are restored on the second virtual machine, receive an error message indicating that an error occurred;
generate a new file comprising vCPU data that describes current conditions of the first virtual machine;
transmit the new file from the first virtual machine to the second virtual machine; and
restore the current conditions of the first virtual machine on the second virtual machine based on the new file.

19. The computing device of claim 13, wherein the processor device is further to:
subsequent to sending the signal to the first virtual machine indicating that the current conditions of the first virtual machine are restored on the second virtual machine, terminate the first virtual machine.

20. A non-transitory computer-readable storage medium that includes computer-executable instructions that, when executed, cause one or more processor devices to:
determine that a workload of a first virtual machine is to be transferred to a second virtual machine;
generate a file comprising virtual CPU (vCPU) data that describes current conditions of the first virtual machine;
transmit the file from the first virtual machine to the second virtual machine;
restore the current conditions of the first virtual machine on the second virtual machine based on the file; and
send a signal to the first virtual machine indicating that the current conditions of the first virtual machine are restored on the second virtual machine.
